(19) United States
(12) Patent Application Publication
(10) Pub. No.: US 2009/0178914 A1
(43) Pub. Date: Jul. 16, 2009

(54) METHOD FOR ACTIVATION OF CHEMICAL OR CHEMICAL-PHYSICAL PROCESSES BY A SIMULTANEOUS USE OF MICROWAVES AND ULTRASONIC PULSES AND CHEMICAL REACTOR THAT CARRIES OUT THIS METHOD

(76) Inventors: Iginio Longo, Pisa (IT); Vittorio Ragaini, Milano (IT)

Correspondence Address: Steinfl & Bruno, 301 N Lake Ave Ste 810, Pasadena, CA, 91101, US

(21) Appl. No.: 12/279,530

(22) PCT Filed: Feb. 13, 2007
(86) PCT No.: PCT/IB2007/000334

§ 371 Date: Nov. 21, 2008

(30) Foreign Application Priority Data
Feb. 17, 2006 (IT) PI2006A000018

(51) Int. Cl. B01J 19/12; B01J 19/10

(52) U.S. Cl. 204/157.15; 422/128

(57) ABSTRACT

An apparatus (1) for activation of chemical-physical processes comprising a microwave source (40), for example a magnetron or a klystron or a solid state oscillator (FET transistor), operatively connected at one end of a microwave antenna, for example a co-axial antenna (3), at a connector (13). The apparatus, furthermore, comprises a generator of electric current (45) at high frequency connected to an ultrasonic transducer (2) for example by a shielded cable, not shown in the FIG. In operative conditions, the antenna (3) and the ultrasonic transducer (2) are arranged substantially at right angles and at direct contact with a reacting mass (15) contained container (10) in order to activate it and then to complete a desired chemical and/or physical process. More in detail, the reacting mass (15) is subject contemporaneously, or alternatively, to an electromagnetic field generated by the antenna (3), diagrammatically indicated (30), and from the ultrasonic field (20) generated by the ultrasonic transducer (2). By arranging the microwave antenna (3) and the ultrasonic transducer (2) in the reacting mass (15) the efficiency of the process is optimized achieving a synergistic effect thanks to the combination of the electromagnetic field and the ultrasonic field.

### FIELD OF THE INVENTION

The present invention relates to a method for activating chemical and/or physical processes hereafter called “chemical-physical processes”, where as energy source ultrasonic waves and microwaves are used at the same time.

Furthermore, the invention relates to an apparatus that carries out this method.

### DESCRIPTION OF THE PRIOR ART

As well known, many chemical and/or physical processes are activated, or in any case enhanced, by high temperature and/or pressure. Therefore, in many cases a mass in a reactor is subject to a energy source that can create these conditions. For increasing temperature, traditionally, a heating apparatus is provided transferring heat to the mass in the reactor by conductivity or convection. For example, devices exist that use ultrasonic waves usually at a frequency set between 20 and 500 kHz to assist the conveying energy processes also through cavitation phenomena. Such apparatus normally provide an electric generator that delivers periodic waves to a transducer comprising a piezoelectric element connected to a vibrating element arranged in a chamber where the reacting mass is present.

More recently a wide diffusion of microwave apparatus has occurred for uses in laboratories and in the industry. In this type of apparatus, a quick variation of an electromagnetic field that penetrates the mass causes its direct heating with a maximum efficiency with respect to the traditional heating methods.

The microwave apparatus provide typically the use of a container, or reactor, of plastic material, or of glass, and in any case of not metallic material, which is arranged to form a closed metal cavity, such as a oven, a resonating cavity or a wave guide for being irradiated by radio waves at high frequency, usually comprised between 10⁹ and 10¹² Hz. More in detail, microwaves propagate in the closed metal cavity by reflection on the inner walls. The microwaves are generated by a Magnetron that causes a electronic beam to oscillate at a very high frequency, thus creating the microwaves, or more recently by solid state oscillating devices. These apparatus have relevant advantages with respect to the traditional heat sources. In fact, they are capable of providing an exceptionally quick heating of the mass in the reactor, quickly reaching higher temperatures than in the apparatus conventionally used.

However, the heating technology with use of microwave ovens or metal wave guides has some drawbacks.

Firstly, the reactors used for this type of technology have to be made of a material that is in general transparent to microwaves. The reactors, are usually closed in microwave ovens or in wave guides, i.e. in metal containers, causing problems to the operator because they block a direct visual, manual and instrumental access. Furthermore, it is not possible to use microwaves in case of reactions that take place at high pressures, since metal reactors with high thicknesses required for these reactions cannot be run across by microwaves.

In the last years, furthermore, studies have been carried out for evaluating the possibility of a combined use of microwaves and ultrasonic pulses. However, such studies have shown that relevant problems exist to use at the same time such technologies. In particular, the introduction of ultrasonic transducers consisting of metal sticks in reactors, or wave guides, irradiated with microwaves, generates electromagnetic interference phenomena. On the other hand the use of ultrasonic pulses in the shape of quartz sticks, i.e. transparent to microwaves, in the microwave resonating cavities reduces the efficiency of the process and does not eliminate the above described drawbacks.

### SUMMARY OF THE INVENTION

It is therefore a first feature of the invention to provide a method for activation of chemical-physical processes by a simultaneous use of microwaves and ultrasonic pulses to increase the efficiency of the processes same.

It is another feature of the invention to provide such a method that is extremely easy, i.e. that can be used in many application fields.

It is also a feature of the invention to provide such a method that is adapted to overcome the difficulties of the prior art.

It is a further feature of the invention to activate chemical-physical processes by a simultaneous use of microwaves and ultrasonic pulses for applying the microwave technology also in the field of reactions that take place in conditions of high pressure.

It is also a feature of the invention to provide such an apparatus that is cheap with respect to apparatus of prior art.

Hereinafter with the term “reaction” a desired type of phenomenon is to be understood that is not exclusively of chemical type, but also of physical type or a combination thereof, and with the expression “reacting mass” a desired type of material subject to this process is to be understood.

These and other features are accomplished with one exemplary method for activation of chemical-physical processes by a simultaneous use of microwaves and ultrasonic pulses comprising the steps of:
generating microwaves by a source of microwave power,
generating ultrasonic pulses by a source of ultrasonic power,
activation of a reacting mass by a combined use of microwaves and of ultrasonic pulses,

whose main feature is that said activation is made by propagating directly in the reacting mass electromagnetic energy and ultrasonic energy, whereby a high efficiency is obtained of the processes same.

In particular, the reacting mass is activated by a simultaneous action, either in phase or out of phase, of a microwave electromagnetic field and of a pressure field operating at ultrasonic frequencies.

Advantageously, before starting the activation step, the reacting mass is previously put in a process chamber.

According to another aspect of the invention, an apparatus for activation of chemical-physical processes by a simultaneous use of microwaves and ultrasonic pulses comprises:
a microwave source,
a source of ultrasonic pulses,
means for transmitting the microwaves generated by the microwave source to a reacting mass,
means for transmitting the ultrasonic pulses obtained from the source of ultrasonic pulses to the reacting mass,

whose main feature is that the means for transmitting the microwaves and the means for transmitting ultrasonic pulses are arranged at direct contact of the reacting mass.

In particular, the apparatus can comprise, furthermore, a process chamber in which the reacting mass is arranged. More in detail, the process chamber can be a reactor for chemical and/or physical applications of the type commonly used in industrial fields or in laboratories. The possibility of putting the means for transmitting the microwaves in the reacting mass and then in the container allows in particular, to make the latter of a metal material. This allows, in particular, to use microwaves also in processes that occur at high pressures and then to increase remarkably the variety of possible applications.

Preferably, the means for transmitting the microwaves comprise at least one microwave antenna, for example of co-axial, type, or in wave guide, arranged at an end of a connector for being operatively connected to the microwave source, and at the other end of a microwave emitter adapted to irradiate onto the reacting mass.

In particular, the end of the antenna at which the transmission of microwaves is carried out can be of the type with dipole, or monopolar type, and have one form selected from the group comprised of:
a spiral,
coated with dielectric material,
with a radiating slit
with more radiating slits,
with metal tip.

Preferably, the ultrasonic transmission means comprises at least one ultrasonic wave emitter having elongated shape. This way, it is possible to position the means for transmitting the microwaves and the ultrasonic transmission means very close to each other optimizing the desired synergistic effect.

Advantageously, in operative conditions the means for transmitting the microwaves and the means for transmitting ultrasonic pulses are arranged substantially at right angles.

In particular, the apparatus can comprise, furthermore, means for measuring at least one parameter of process, for example pressure or temperature.

Furthermore, the apparatus can provide also means for mixing the reacting mass, for example a mixer of the type with magnetic bar.

Advantageously, the reaction container can provide a coating layer of a heat-insulating material.

Advantageously, the antenna is coated with a closed sheath of inert material, for example PTFE, glass, ceramic etc., adapted to avoid a direct contact with the reagents.

In particular, means can be provided for modulating the frequency of microwaves and means for modulating ultrasonic frequency to adjust the power transmitted to the reacting mass responsive to the type of process.

The apparatus for activation of chemical and/or physical processes, as above described, increases considerably the control, the speed, the selectivity and the tightness of the processes for which it is employed.

In case of use of high energy power to avoid residual emissions out of the reaction container, a shielding layer opaque to microwaves can be provided, for example, a film, a varnish, or a metal net.

According to a further aspect of the invention the method for activation of chemical-physical processes by a simultaneous use of microwaves and ultrasonic pulses above described can be advantageously used for one of the following applications:
removing pollutants present in the ground water table,
extracting active principles from solid materials,
extracting pollutants from polluted soil.

### BRIEF DESCRIPTION OF THE DRAWINGS

The invention will be now shown with the following description of an exemplary embodiment thereof, exemplifying but not limitative, with reference to the attached drawings wherein:

FIG. 1 shows diagrammatically an elevational front view of a apparatus for activation of chemical-physical processes by a simultaneous use of microwaves and ultrasonic pulses, according to the invention,

FIG. 2 shows diagrammatically an elevational front view of a first exemplary embodiment of a reaction chamber that can be used in the apparatus of FIG. 1,

FIG. 3 shows diagrammatically an elevational front view of a further exemplary embodiment of a reaction chamber that can be used in the apparatus of FIG. 1,

FIG. 4 shows a possible application of the method for activation of chemical-physical processes by a simultaneous use of microwaves and ultrasonic pulses, according to the invention.

### DESCRIPTION OF THE PREFERRED EMBODIMENTS

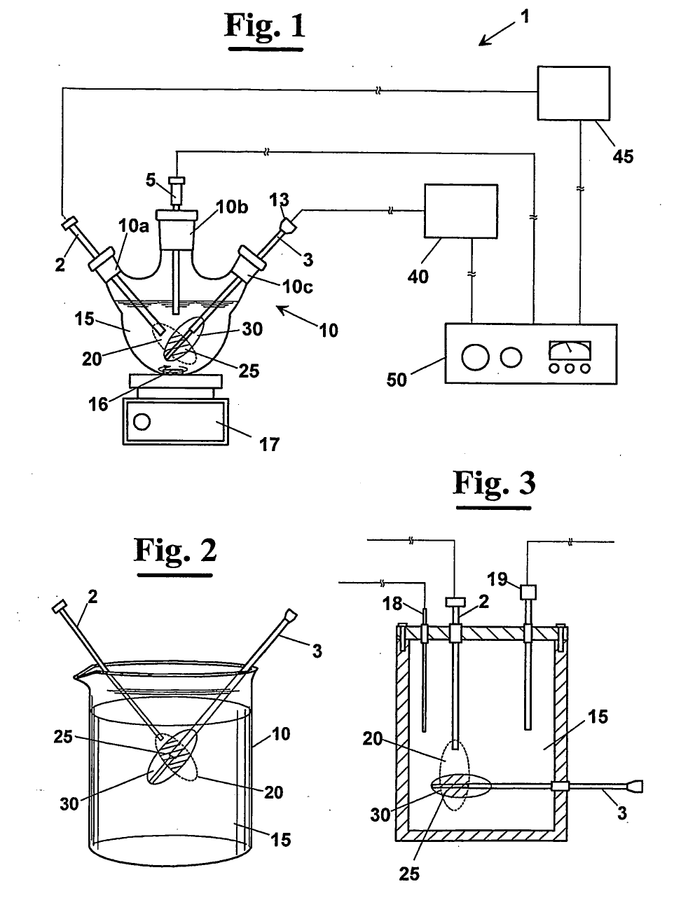

In FIG. 1 an apparatus 1 is diagrammatically shown for activation of chemical-physical processes, according to the invention. It comprises a microwave source 40, for example a Magnetron or a Klystron or a solid state oscillator (FET transistor), operatively connected at one end of a microwave antenna, for example a co-axial antenna 3, at a connector 13. The apparatus, furthermore, comprises a generator of electric current 45 at high frequency connected to an ultrasonic transducer 2 for example by a shielded cable, not shown in the FIG. In operative conditions, the antenna 3 and the ultrasonic transducer 2 are arranged substantially at right angles and at direct contact with a reacting mass 15 contained in container 10 in order to activate it and then to complete the desired chemical and/or physical process. More in detail, the reacting mass 15 is subject contemporaneously, or alternatively, to an electromagnetic field generated by antenna 3, diagrammatically indicated in figure by line 30, and from the ultrasonic field 20 generated by the ultrasonic transducer 2.

The arranging the microwave antenna 3 and of the ultrasonic transducer 2 in the reacting mass 15 allows to optimize the efficiency of the process through a synergistic effect of the electromagnetic field and of the ultrasonic field.

The process chamber can be a common container for laboratories, for example a sphere with 3 apertures 10a, 10b and 10c (FIG. 1), or a beaker (FIG. 2), and can be of glass or other inert material, and also with metal walls, which can be coated with a inner layer of PTFE, alumina, or other resistant material at high temperature and pressures. The possibility to use containers that are common in laboratories, without the need of arranging them in ovens or metal cavities, provides considerable savings with respect to apparatus of prior art. Furthermore, the reaction site is easily accessible, for example to introduce in it measuring instruments such as temperature sensors 5 (FIG. 1), or pressure sensors 19 (FIG. 3). This way, it is possible to monitor instantly the operative conditions and intervene therefore in real time on the modular process parameters at the frequency and the power of the ultrasonic waves and of microwaves.

In case it is necessary to use high power reaction container 10 can be coated with a shielding layer next to the external walls and opaque to microwaves. This prevents propagation of microwaves out of the container avoiding losses and allowing the operators to operate in conditions of extreme safety. The shielding layer can be made for example, by a film, a varnish, or a metal net that reflect microwaves back to the reacting mass 15. For mixing effectively the reacting mass 15, in the reaction container 10 a magnetic bar 16 (FIG. 1) can be put that is rotated the reacting mass 15 by a stirring magnet 17. As diagrammatically shown in FIG. 3, in case of processes carried out at high pressures it is possible to use reaction containers 10 made with metal walls of high thickness that have an aperture for introducing the antenna 3 of the sender of ultrasonic pulses 2 and instruments for measuring the process parameters 18 and 19.

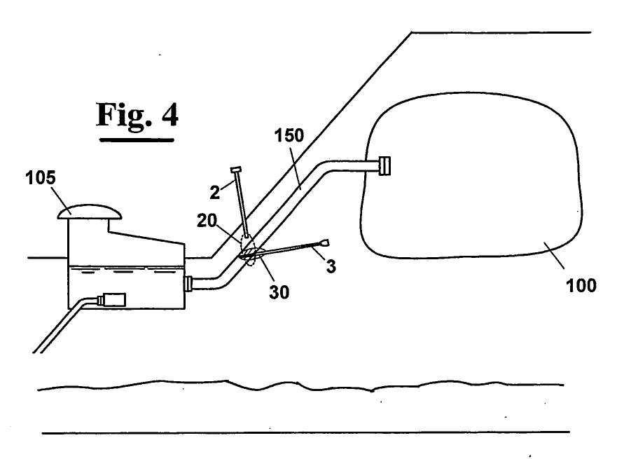

The method, according to the invention, has furthermore, a high versatility and provides very different applications. In particular, the methodology proposed is applicable even with reacting mass 15 not necessarily contained in a container of process 10. For example, as shown in FIG. 4 it is possible to use the antenna 3 and the sender of ultrasonic pulses 2 in the way above described for removing the pollutants present in liquid flows present in ducts 150 connected to a ground water table 100 and a sorting plant 105. It is to be understood that the method and the apparatus as above described can be used both in processes working continuously and in processes working discontinuously.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. A method for activation of chemical-physical processes by a simultaneous use of microwaves and ultrasonic pulses, the method comprising the steps of:
generating microwaves by a source of microwave power,
generating ultrasonic pulses by a source of ultrasonic power,
activating a reacting mass by the combined use of microwaves and of ultrasonic pulses,
wherein activating said reacting mass is performed by propagating directly in the reacting mass electromagnetic energy and ultrasonic energy.

2. The method according to claim 1, wherein said reacting mass is activated by a simultaneous action, either in phase or out of phase, of a microwave electromagnetic field and of a pressure field at ultrasonic frequency.

3. An apparatus for activation of chemical-physical processes by a simultaneous use of microwaves and ultrasonic pulses, the apparatus comprising:
a microwave source,
a source of ultrasonic pulses,
means for transmitting fee microwaves generated by said microwave source to a reacting mass,
means for transmitting fee ultrasonic pulses obtained from said source of ultrasonic pulses to said reacting mass,
wherein said means for transmitting microwaves and said means for transmitting ultrasonic pulses are arranged to be in direct contact with said reacting mass.

4. The apparatus according to claim 3, further comprising a process chamber in which the reacting mass is arranged.

5. The apparatus according to claim 3, wherein said means for transmitting said microwaves comprises at least one microwave antenna, a microwave emitter and a connector, and wherein the at least one microwave antenna is arranged at one end of the connector, the connector is adapted to allow connection of the microwave antenna to said microwave source, the microwave antenna is further connected with the microwave emitter, and the microwave emitter is adapted to irradiate onto said reacting mass.

6. The apparatus according to claim 5, wherein said microwave antenna is selected from the group consisting of:
a dipole, and
a monopole.

7. The apparatus according to claim 5, wherein said microwave antenna has a shape selected from the group consisting of:
a spiral,
a shape coated with dielectric material,
a shape coated with a radiating slit
a shape coated with a plurality of radiating slits,
a shape coated with a metal tip.

8. The apparatus according to claim 3, wherein said ultrasonic transmission means comprises at least one transducer of ultrasonic waves, the transducer having an elongated shape.

9. The apparatus according to claim 3, wherein said means for transmitting the microwaves and said means for transmitting ultrasonic pulses are arranged at substantially ninety degrees angles.

10. The apparatus according to claim 3, further comprising means for measuring at least one process parameter.

11. The apparatus according to claim 4, further comprising means for mixing said reacting mass in said process chamber.

12. The apparatus according to claim 4, wherein said reaction container has a coating layer of heat-insulating material.

13. The apparatus according to claim 4, wherein said antenna is coated with a closed sheath of inert material, the closed sheath of inert material adapted to avoid a direct contact with the reagents.

14. The apparatus according to claim 3, further comprising means for modulating frequencies of said microwaves and means for modulating frequencies of said ultrasonic pulses to adjust the power transmitted to said reacting mass so that said power is responsive to the type of process.

15. The apparatus according to claim 4, wherein said reaction container has a shielding layer, the shielding layer opaque to said microwaves
